(19) United States
(12) Patent Application Publication
(10) Pub. No.: US 2025/0231554 A1
(43) Pub. Date: Jul. 17, 2025

(54) PLANT OPERATION SIMULATION SYSTEM AND PLANT OPERATION SIMULATION METHOD

(71) Applicant: MITSUBISHI HEAVY INDUSTRIES, LTD., Tokyo (JP)

(72) Inventors: Minoru NAKAIDE, Tokyo (JP); Shinichi TODA, Tokyo (JP)

(21) Appl. No.: 18/683,949

(22) PCT Filed: Nov. 25, 2022
(86) PCT No.: PCT/JP2022/043484

§ 371 Date: Feb. 15, 2024

(30) Foreign Application Priority Data
Dec. 3, 2021 (JP) 2021-196649

(51) Int. Cl. G05B 19/418

(52) U.S. Cl. CPC G05B 19/41885

(57) ABSTRACT

In this plant operation simulation system, a control device provides a time stamp to a snapshot of a calculation result by a control function of the control device at an arbitrarily defined time and transfers the snapshot to an emulator. By using the calculation result included in the snapshot transferred from the control device and input data to which a time stamp at or after a time indicated by the time stamp provided to the snapshot is provided, the emulator executes boost calculation for calculating a control model of the emulator at a cycle faster than the cycle of calculation by the control function of the control device until reaching a calculation time of the control function in the control device at a current time point.

### TECHNICAL FIELD

The present disclosure relates to a plant operation simulation system and a plant operation simulation method.

The present application claims priority based on Japanese Patent Application No. 2021-196649 filed in Japan on Dec. 3, 2021, the contents of which are incorporated herein by reference.

### BACKGROUND ART

PTL 1 discloses an online simulation system configured with a process control device that controls an final control element of a valve, a damper, or the like based on a state quantity of a plant and an emulator for a function confirmation test of the process control device.

In this system, switching between a process control mode and a simulation mode is performed online according to a command from a user, and switching between input/output of the control device and the actual plant, and input/output of the control device and a plant model in the emulator is performed.

### CITATION LIST

### Patent Literature

[PTL 1] Japanese Unexamined Patent Application Publication No. S62-22101

### SUMMARY OF INVENTION

### Technical Problem

In the simulation system described in PTL 1, since the operation of the control function cannot be checked while the control device is operating the plant in a normal control mode, it is not possible to check in advance whether or not an output value from the control device to the plant is suddenly changed due to change in a control logic (for example, parameter adjustment of the control function, circuit change, or the like) of the control device.

In view of the above-mentioned circumstances, at least one embodiment of the present disclosure aims to provide a plant operation simulation system and a plant operation simulation method capable of checking an effect of change in the control logic in the control device, which controls the plant, on the output value of the control device, before the control logic is changed while the plant is in operation.

### Solution to Problem

In order to achieve the above object, a plant operation simulation system according to at least one embodiment of the present disclosure includes: a control device that has a control function of outputting output data for controlling a plant by receiving input data related to a state quantity of the plant; and an emulator that includes a control model simulating the control function of the control device and that is time-synchronized with the control device, in which the control device and the emulator are configured to receive the input data at a cycle common to the control device and the emulator, the emulator is configured to add a time stamp to the input data received by the emulator and store the input data in a storage device, the control device is configured to add a time stamp to a snapshot of a calculation result obtained by using the control function of the control device at any time and transfer the snapshot to the emulator, and the emulator is configured to execute a boost calculation for performing a calculation of the control model of the emulator at a cycle faster than a cycle of a calculation performed by using the control function of the control device until reaching a calculation time of the control function in the control device at a current time point, by using the calculation result included in the snapshot transferred from the control device and the input data to which a time stamp at or after the time, which is indicated by the time stamp added to the snapshot, is added.

In order to achieve the above object, a plant operation simulation method according to at least one embodiment of the present disclosure is a plant operation simulation method of using a control device that has a control function of outputting output data for controlling a plant by receiving input data related to a state quantity of the plant and an emulator that includes a control model simulating the control function of the control device and that is time-synchronized with the control device, the plant operation simulation method including: a step of causing the control device and the emulator to receive the input data at a cycle common to the control device and the emulator, a step of adding a time stamp to the input data received by the emulator and storing the input data, a step of adding a time stamp to a snapshot of a calculation result obtained by using the control function of the control device at any time and transferring the snapshot to the emulator, and a step of executing a boost calculation for performing a calculation of the control model of the emulator at a cycle faster than a cycle of a calculation performed by using the control function of the control device until reaching a calculation time of the control function in the control device at a current time point, by using the calculation result included in the snapshot and the input data to which a time stamp at or after the time, which is indicated by the time stamp added to the snapshot, is added.

### Advantageous Effects of Invention

According to at least one embodiment of the present disclosure, there is provided a plant operation simulation system and a plant operation simulation method capable of checking an effect of change in a control logic in a control device, which controls a plant, on an output value of the control device, before the control logic is changed while the plant is in operation.

### BRIEF DESCRIPTION OF DRAWINGS

FIG. 1 is a schematic configuration diagram of a plant operation simulation system 2 (2A) according to an embodiment.

FIG. 2 is a diagram for describing an example of a hardware configuration of each of a control device 4, an emulator 6, and a man-machine device 8.

FIG. 3 is a time chart for describing a method of reproducing an operating state of a plant 100 with an emulator 6.

FIG. 4 is a schematic configuration diagram of a plant operation simulation system 2 (2B) according to another embodiment.

FIG. 5 is a time chart for describing a method of reproducing an operating state of the plant 100 with the emulator 6, in the plant operation simulation system 2 (2B).

FIG. 6 is a schematic configuration diagram of a plant operation simulation system 2 (2C) according to still another embodiment.

FIG. 7 is a time chart for describing another example of a method of reproducing an operating state of the plant 100 with the emulator 6, in the plant operation simulation system 2 (2A).

### DESCRIPTION OF EMBODIMENTS

Hereinafter, some embodiments of the present disclosure will be described with reference to the accompanying drawings. Dimensions, materials, shapes, relative arrangements, and the like of components described as embodiments or illustrated in the drawings are not intended to limit the scope of the invention, but are merely explanatory examples.

For example, an expression representing a relative or absolute arrangement such as “in a certain direction”, “along a certain direction”, “parallel”, “orthogonal”, “center”, “concentric”, or “coaxial” does not strictly represent only such an arrangement, but also a tolerance or a state of being relatively displaced with an angle or a distance to the extent that the same function can be obtained.

For example, an expression such as “identical”, “equal”, or “homogeneous” representing a state where things are equal to each other does not strictly represent only the equal state, but also a tolerance or a state where there is a difference to the extent that the same function can be obtained.

For example, an expression representing a shape such as a quadrangular shape or a cylindrical shape does not represent only a shape such as a quadrangular shape or a cylindrical shape in a geometrically strict sense, but also a shape including an uneven portion, a chamfered portion, and the like within a range in which the same effect can be obtained.

Meanwhile, the expressions “being provided with”, “comprising”, “including”, or “having” one component are not exclusive expressions excluding the presence of other components.

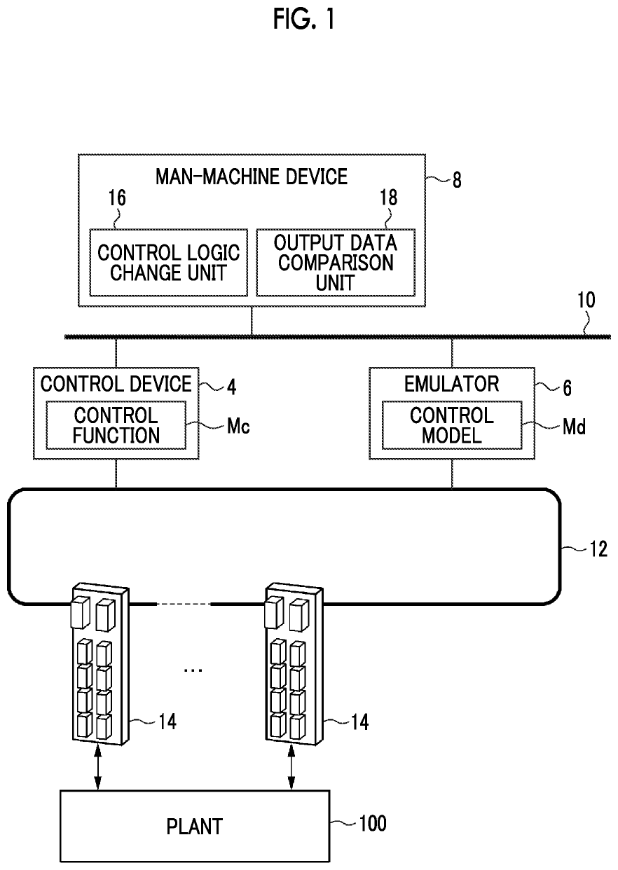

FIG. 1 is a schematic configuration diagram of a plant operation simulation system 2 (2A) according to an embodiment.

The plant operation simulation system 2 shown in FIG. 1 includes a control device 4 for controlling a plant 100, an emulator 6 simulating a function of the control device 4, and a man-machine device 8 for performing a plant operation or the like of the plant 100. The type of the plant 100 is not limited, and may be, for example, a power generation plant, a chemical plant, or the like.

The control device 4, the emulator 6, and the man-machine device 8 are configured to be connected to each other with an information communication network 10 and to be capable of communicating with each other. Further, the control device 4 and the emulator 6 are connected to each other with a control communication network 12, which is different from the information communication network 10, and a plurality of input/output modules 14 are connected to the control communication network 12. Details of the functions of these configurations will be described later.

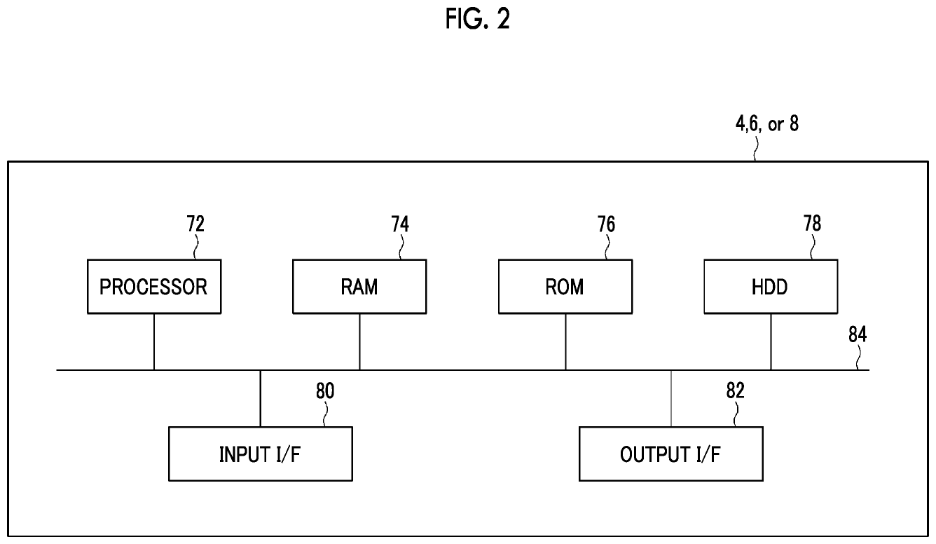

FIG. 2 is a diagram for describing an example of a hardware configuration of each of the control device 4, the emulator 6, and the man-machine device 8. Here, the hardware configuration of each of the control device 4, the emulator 6, and the man-machine device 8 will be described with reference to the identical figures for convenience.

As shown in FIG. 2, each of the control device 4, the emulator 6, and the man-machine device 8 includes, for example, a processor 72, a random access memory (RAM) 74, a read only memory (ROM) 76, a hard disk drive (HDD) 78, an input I/F 80, and an output I/F 82, and these are configured using computers connected to each other via a bus 84. The hardware configuration of each of the control device 4, the emulator 6, and the man-machine device 8 is not limited to the above, and may be configured with a combination of a control circuit and a storage device. Further, each of the control device 4, the emulator 6, and the man-machine device 8 is configured with a computer executing a program for implementing each function. Each of the functions of the control device 4, the emulator 6, and the man-machine device 8 described below is implemented, for example, by loading the program, which is stored in the ROM 76, into the RAM 74 to execute with a processor 72 and performing write and read of data in the RAM 74 or the ROM 76. Instead of the HDD 78 shown as an example of a non-volatile memory or together with the HDD 78, another non-volatile storage medium such as SD/CF/SSD may be used. Further, the program stored in the ROM 76 may be stored in the HDD 78 or another non-volatile storage medium, and is loaded into the RAM 74 and is executed with the processor 72.

As shown in FIG. 1, the control device 4 includes a control function Mc for controlling the plant 100 and controls the plant 100 by using the control function Mc. The control device 4 exchanges various types of data with the plant 100 via at least one input/output module 14 (the plurality of input/output modules 14 in the illustrated example). The control function Mc of the control device 4 outputs output data (for example, control command values for controlling final control elements such as valves and dampers provided in the plant 100) for controlling the plant 100 by receiving input data indicating a state quantity of the plant 100 from the plant 100 via the input/output module 14.

The emulator 6 includes a control model Md simulating the control function Mc of the control device 4, and the control device 4 and the emulator 6 are time-synchronized. The time synchronization between the control device 4 and the emulator 6 may be performed by, for example, time adjustment using a precision time protocol (PTP) or the like. For example, the control function Mc of the control device 4 and the control model Md of the emulator 6 may be downloaded from the man-machine device 8 and installed in each of the control device 4 and the emulator 6.

The control device 4 and the emulator 6 are configured to receive each of all the input data, which is input from the plant 100 via the input/output module 14, at a cycle common to the control device 4 and the emulator 6. Further, the emulator 6 adds a time stamp of reception time to each of all the input data received by the emulator 6 and stores the input data in the storage device of the emulator 6 (for example, the HDD 78 of the emulator 6).

The man-machine device 8 is a man-machine for an operator to perform monitoring and plant operation of the plant 100. The man-machine device 8 includes a control logic change unit 16 and an output data comparison unit 18.

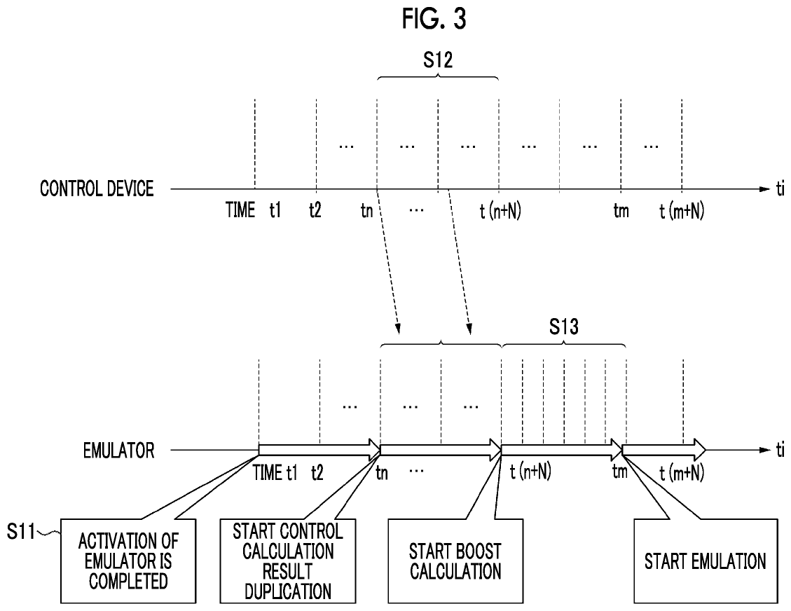

FIG. 3 is a time chart for describing a method of reproducing an operating state of the plant 100 with the emulator 6.

In FIG. 3, a horizontal axis ti (i is an integer of 1 or more) indicates a calculation time in each of the control device 4 and the emulator 6. As shown in FIG. 3, the emulator 6 is activated while the plant 100 is in operation, and the activation of the emulator 6 is completed at time t1 (step S11).

Next, the control device 4 adds, to a snapshot Qn of a calculation result (an intermediate value of a calculation performed by using the control function Mc) obtained by using the control function Mc of the control device 4 at certain time tn after the emulator 6 is activated, a time stamp of the time tn and stores the snapshot Qn in the storage device (for example, the RAM 74 of the control device 4 or the like) of the control device 4, and transfers the snapshot Qn to which the time stamp of the time tn is added to the emulator 6 (step S12). In the illustrated example, the control device 4 divides the snapshot Qn to which the time stamp of the time tn is added into a plurality of data and transfers the plurality of data to the emulator 6 over N times of calculation cycles. Here, N is plural, and the control device 4 transfers the snapshot Qn to the emulator 6 over N times of calculation cycles from time tn to time t(n+N). That is, the emulator 6 starts duplication, at the time tn, of the calculation result of the control device 4 at the time tn and completes the duplication at the time t(n+N).

Next, the emulator 6 executes a boost calculation for performing a calculation of the control model Md of the emulator 6 at a cycle faster than a cycle of a calculation performed by using the control function Mc of the control device 4 until reaching a calculation time of the control function Mc in the control device 4 at a current time point, by using the calculation result (the calculation result of the control function Mc at the time tn) included in the snapshot Qn transferred from the control device 4 and the input data (the input data stored in the storage device of the emulator 6) to which a time stamp at or after the time tn, which is the time indicated by the time stamp added to the snapshot Qn (step S13), is added. Hereinafter, a “boost calculation” refers to the boost calculation of the emulator 6 in step S13. The emulator 6 uses the calculation result of the control function Mc at the time tn included in the snapshot Qn transferred from the control device 4 as an initial value of the boost calculation. In the illustrated example, at the time t(n+N), the emulator 6 starts the boost calculation by using the calculation result of the control function Mc at the time tn (the intermediate value of the calculation performed by using the control function Mc) and the input data to which the time stamp at or after the time tn is added (the input data stored in the storage device of the emulator 6), and ends the boost calculation by catching up with the calculation of the control function Mc in the control device 4 at time tm. As a result, at or after the time tm, the operating state of the plant 100 can be reproduced by the emulator 6.

An emulation performed by the emulator 6 is started at the time tm, and at or after the time tm, the calculation cycle of the control function Mc performed by the control device 4 and the calculation cycle of the control model Md performed by the emulator 6 become identical. At or after the time tm, that is, after the boost calculation, when the operator of the plant 100 operates the control logic change unit 16 and the control logic of the control model Md of the emulator 6 is changed, the output data comparison unit 18 compares output data, which is output from the control model Md of the emulator 6, and output data, which is output from the control function Mc of the control device 4. For example, the output data comparison unit 18 may be configured to display the output data of the control device 4 and the output data of the emulator 6 in comparison on a display device (not shown), and may be configured to calculate a difference value between an output value of the control device 4 and an output value of the emulator 6 and output an alert sound and/or an alert display for notifying the operator of the possibility of a sudden change in the output value when the difference value exceeds a threshold value.

Here, the effect of the plant operation simulation system 2 will be described.

In the plant operation simulation system 2, the emulator 6, which is time-synchronized with the control device 4 and includes the control model Md simulating the control function Mc, executes the boost calculation for performing the calculation of the control model Md of the emulator 6 at the cycle faster than the cycle of the calculation performed by using the control function Mc of the control device 4 until reaching a calculation time of the control function Mc in the control device 4 at a current time point, using by the calculation result (the intermediate value of the calculation performed by using the control function Mc), at the time tn, included in the snapshot Qn transferred from the control device 4 and the input data (the input data input from the plant 100 to the emulator 6 via the input/output module 14 and stored in the storage device of the emulator 6) to which a time stamp at or after the time tn, which is the time indicated by the time stamp added to the snapshot Qn, is added. Therefore, the operating state of the plant 100 at a certain time point can be reproduced by the emulator 6 which is a device different from the control device 4. Therefore, an effect (for example, whether the output value of the control device 4 is changed suddenly or the like) of change in the control logic, when the change is made in the control logic of the control device 4 from this state, on the output value of the control device 4 can be checked by using the emulator 6 before the control logic of the control device 4 is changed while the plant 100 is in operation. Therefore, it is possible to reduce a risk of an emergency stop of a control target of the plant 100 or an unexpected accident.

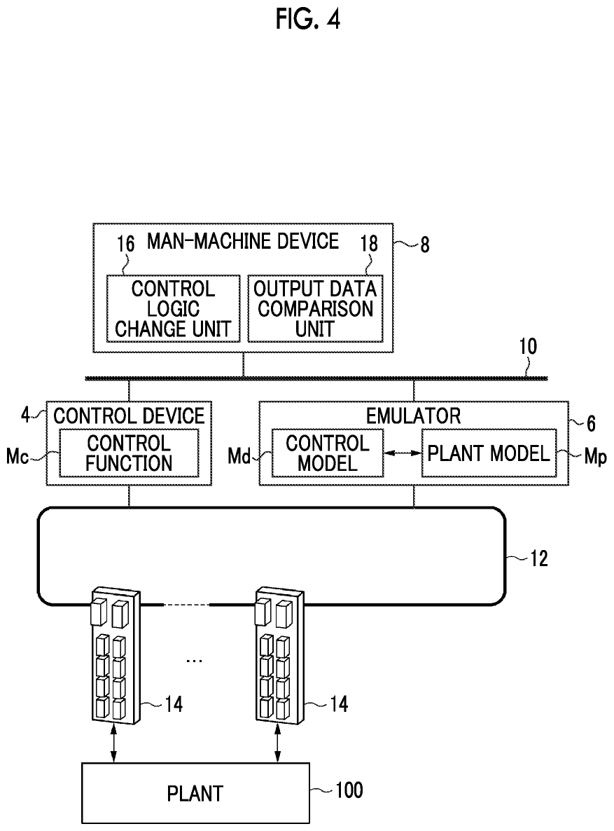

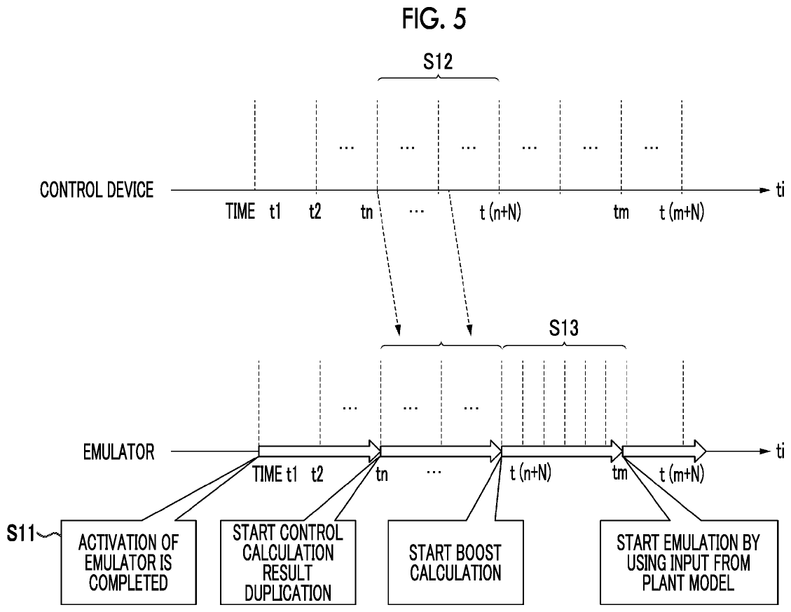

FIG. 4 is a schematic configuration diagram of a plant operation simulation system 2 (2B) according to another embodiment. FIG. 5 is a time chart for describing a method of reproducing an operating state of the plant 100 with the emulator 6, in the plant operation simulation system 2 (2B).

The plant operation simulation system 2 (2B) shown in FIG. 4 differs from the plant operation simulation system 2 (2A) shown in FIG. 1 in that the emulator 6 includes a plant model Mp that is a model simulating the plant 100, and the other basic configuration is the same as that of the plant operation simulation system 2 (2A). In the plant operation simulation system 2 (2B) according to the embodiment shown in FIG. 4, unless otherwise specified, the symbols common to each configuration of the plant operation simulation system 2 (2A) shown in FIG. 1 indicate the same configuration as each configuration of the plant operation simulation system 2 (2vA) shown in FIG. 1, and description thereof will be omitted. Further, in the time chart shown in FIG. 5, the operations of the control device 4 and the emulator 6 until the boost calculation is completed at the time tm are identical to those described with reference to FIG. 3, and thus, the description thereof will be omitted.

The output data of the control model Md of the emulator 6 is input to the plant model Mp shown in FIG. 4. The plant model Mp generates input data to be input to the control model Md of the emulator 6 in accordance with the output data of the control model Md of the emulator 6. The plant model Mp interfaces with the control model Md of the emulator 6 (exchanges data) at a cycle of the control calculation of the control model Md of the emulator 6. As shown in FIG. 5, at the time tm, the emulator 6 starts emulation by using the input data generated with the plant model Mp.

In the example shown in FIG. 5 as well, at or after the time tm, the calculation cycle of the control function Mc performed by the control device 4 and the calculation cycle of the control model Md performed by the emulator 6 are identical. Further, at or after the time tm, that is, after the boost calculation, when the operator of the plant 100 operates the control logic change unit 16 and the control logic of the control model Md of the emulator 6 is changed, the output data comparison unit 18 compares output data, which is output from the control model Md of the emulator 6, and output data, which is output from the control function Mc of the control device 4, by using the method described above.

According to the plant operation simulation system 2 (2B), by checking the effect of change in the control logic of the control model Md of the emulator 6 on the input data generated with the plant model Mp, it is possible to understand the effect of change in the control logic of the control function Mc of the control device 4 on the output of the plant 100. Therefore, the control logic of the control function of the control device 4 can be appropriately adjusted in consideration of the input data generated with the plant model Mp.

In the exemplary embodiment shown in FIG. 4, although the plant model Mp is provided inside the emulator 6, the plant model Mp may be provided outside the emulator 6 as long as the plant model Mp can exchange input/output data with respect to the control model Md of the emulator 6. When the emulator 6 includes the plant model Mp, and when the plant model Mp also includes snapshot data and is configured to perform calculation in synchronization with the control model Md, it is not necessary to use the boost calculation to catch up with the current plant operating state, and the simulation can be started from the time point when the snapshot is loaded (duplication start of control calculation result), and when the calculation is performed faster than the actual control calculation cycle, a predictive calculation exceed the current time point becomes possible.

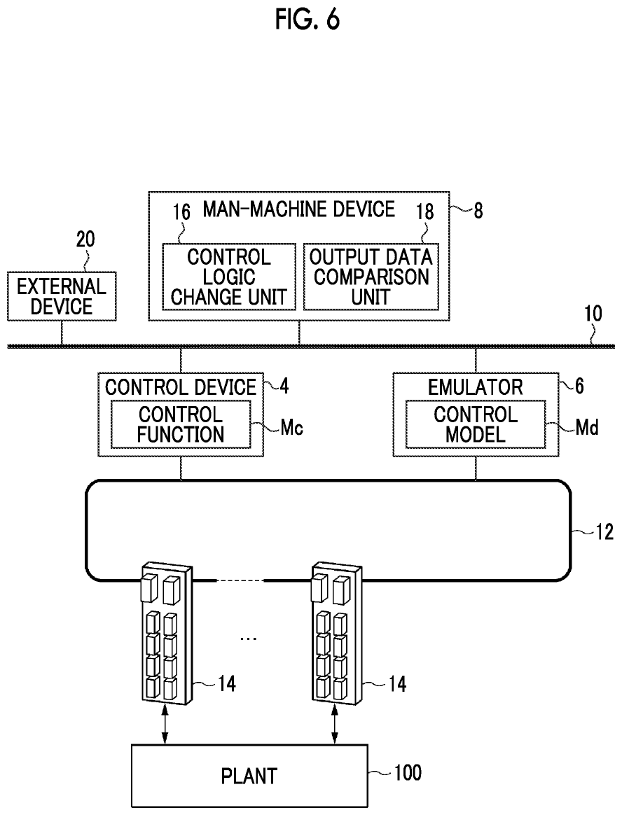

FIG. 6 is a schematic configuration diagram of a plant operation simulation system 2 (2C) according to still another embodiment.

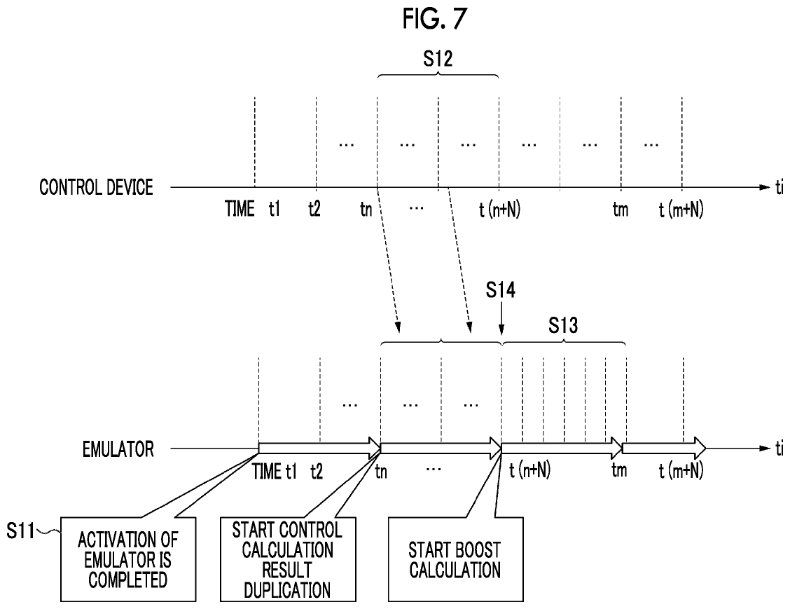

The plant operation simulation system 2 (2C) shown in FIG. 6 differs from the plant operation simulation system 2 (2A) shown in FIG. 1 in some of the functions of the control device 4 and the emulator 6, and the other basic configuration is the same as that of the plant operation simulation system 2 (2A). In the plant operation simulation system 2 (2C) according to the embodiment shown in FIG. 6, unless otherwise specified, the symbols common to each configuration of the plant operation simulation system 2 (2A) shown in FIG. 1 indicate the same configuration as each configuration of the plant operation simulation system 2 (2A) shown in FIG. 1, and description thereof will be omitted. Further, unless otherwise specified, the operations of the control device 4 and the emulator 6 described with reference to FIG. 7 are identical to those described with reference to FIG. 3, and thus, the description thereof will be omitted.

In the plant operation simulation system 2 (2C), the control device 4 adds a time stamp of the reception time of the reception data to the reception data, which is received by the control device 4 in addition to the input data from the plant 100, and transfers the reception data to the emulator 6. Specifically, for example, when the control device 4 receives an operation command for operating the plant 100 from the man-machine device 8, and when the control device 4 receives communication data from another external device 20, the control device 4 adds a time stamp of the reception time to the received reception data (the operation command from man-machine device 8 or the communication data from the other external device 20) and transfers the reception data to the emulator 6. At this time, a passage for transferring the reception data from the control device 4 to the emulator 6 may be the information communication network 10 or the control communication network 12.

The emulator 6 stores the reception data, which is received from the control device 4, in the storage device of the emulator 6 (for example, the HDD 78 of the emulator 6) and reproduces the reception data at the time indicated by the time stamp added to the reception data while the boost calculation is being executed. In the example of the time chart shown in FIG. 7, at or after time t1, similarly to the control device 4, the emulator 6 takes the input data from the plant 100, the operation command from the man-machine device 8, and the communication data from the external device 20, and stores the input data, the operation command, and the communication data in the storage device of the emulator 6. Further, the emulator 6 performs the boost calculation from the time t(n+N) to the time tm by using the calculation result included in the snapshot Qn transferred from the control device 4 (the calculation result of the control function Mc of the control device 4 at the time tn), the input data (the input data from the plant 100 stored in the storage device of the emulator 6) to which a time stamp at or after the time tn, which is the time indicated by the time stamp added to the snapshot Qn, is added, and the reception data (the operation command from the man-machine device 8 and the communication data from the external device 20) stored in the storage device of the emulator 6.

According to the plant operation simulation system 2 (2C), even when the control device 4 receives communication data from other external devices 20 and receives an operation command from the man-machine device 8, and a state of the control logic of the control function of the control device 4 is changed, in a process of duplicating the operating state of the plant 100 at certain time point (including an internal state of the control device 4) with the emulator 6, the operating state of the plant 100 can be duplicated by the emulator 6.

FIG. 7 is a time chart for describing another example of a method of reproducing the operating state of the plant 100 with the emulator 6 and shows a modification example of the time chart shown in FIG. 3, in the plant operation simulation system 2 (2A).

In the time chart shown in FIG. 7, the operations of the control device 4 and the emulator 6 until the boost calculation is completed at the time tm are identical to those described with reference to FIG. 3, and thus, the description thereof will be omitted.

In the example shown in FIG. 7, after the emulator 6 starts the emulation at the time tm, step S12 and storing the snapshot data in the emulator 6 and storing the input data that is input from the plant 100 via the input/output module 14 are repeated. The snapshot, which is stored through in step S12, and the input data (the input data input via the input/output module 14), which is stored between the snapshot storing intervals, are reproduced immediately before the start of the boost calculation (this reproduction is performed in step S14), and steps S14 and S13 are performed. Steps S14 and S13 may be repeated, and the result of step S13 may be stored in the emulator 6 as reproduction data for investigating the cause of a trip. The emulator 6 is configured to be capable of performing the boost calculation by using each of the snapshots stored in the storage device of the emulator 6 and to store the calculation result (the intermediate value of the calculation performed by using the control function Mc) included in each of the snapshots transferred from the control device 4 and each of the calculation results of the boost calculations in step S13, in the storage device (for example, the HDD 78 of the emulator 6) of the emulator 6.

As a result, the calculation result of the control function Mc of the control device 4 and the result of the boost calculation can be sequentially stored in the emulator 6. As a result, when a trip or the like occurs in the plant 100, it becomes possible to check a past calculation state in the control device 4 by using the snapshot stored in the storage device of the emulator 6, and the cause of the trip can be investigated.

The present disclosure is not limited to the embodiments described above and includes a form in which a modification is added to the embodiments described above or a form in which the above forms are combined as appropriate.

The contents described in each embodiment are understood as follows, for example.

(1) A plant operation simulation system according to at least one embodiment of the present disclosure includes: a control device (for example, the control device 4) that has a control function (for example, the control function Mc) of outputting output data for controlling a plant by receiving input data related to a state quantity of the plant; and an emulator (for example, the emulator 6) that includes a control model (for example, the control model Md) simulating the control function of the control device and that is time-synchronized with the control device, in which the control device and the emulator are configured to receive the input data at a cycle common to the control device and the emulator, the emulator is configured to add a time stamp to the input data received by the emulator and store the input data in a storage device, the control device is configured to add a time stamp to a snapshot (for example, the snapshot Qn) of a calculation result obtained by using the control function of the control device at any time (for example, the time tn) and transfer the snapshot to the emulator, and the emulator is configured to execute a boost calculation for performing a calculation of the control model of the emulator at a cycle faster than a cycle of a calculation performed by using the control function of the control device until reaching a calculation time of the control function in the control device at a current time point, by using the calculation result included in the snapshot transferred from the control device and the input data to which a time stamp at or after the time, which is indicated by the time stamp added to the snapshot, is added.

In the plant operation simulation system described in (1) above, the emulator, which is time-synchronized with the control device and includes the control model simulating the control function, executes the boost calculation for performing the calculation of the control model of the emulator at the cycle faster than the calculation cycle of the control function of the control device until reaching a calculation time of the control function in the control device at a current time point, by using the calculation result (the intermediate value of the calculation performed by using the control function), at a certain time point, included in the snapshot transferred from the control device and the input data to which a time stamp at or after the time, which is indicated by the time stamp added to the snapshot, is added. Therefore, the operating state of the plant at a certain time point can be reproduced by the emulator which is different from the control device. Therefore, an effect (for example, whether the output value of the control device is changed suddenly or the like) of change in the control logic, when the change is made in the control logic of the control device from this state, on the output value of the control device can be checked by using the emulator before the control logic of the control device is changed while the plant is in operation. Therefore, it is possible to reduce a risk of an emergency stop of a control target of the plant or an unexpected accident.

(2) In some embodiments, in the plant operation simulation system described in (1), the emulator is configured to use the calculation result, which is included in the snapshot transferred from the control device, as an initial value of the boost calculation.

According to the plant operation simulation system described in (2) above, the operating state of the plant is appropriately reproduced by the emulator by executing the boost calculation using the calculation result of the control device, which is included in the snapshot, as the initial value of the boost calculation.

(3) In some embodiments, in the plant operation simulation system described in (1) or (2), the control device is configured to divide the snapshot into a plurality of data and transfer the plurality of data to the emulator over a plurality of calculation cycles (for example, N times of calculation cycles).

According to the plant operation simulation system described in (3) above, it is possible to suppress an increase in a load caused by the transfer in the control device, as compared with a case where the snapshot is transferred to the emulator in only one cycle of the calculation.

(4) In some embodiments, plant operation simulation system described in any one of (1) to (3) further includes an output data comparison unit (for example, the output data comparison unit 18) that is configured to compare output data, which is output from the control model of the emulator, and output data, which is output from the control function of the control device, when a control logic of the control model of the emulator is changed after the boost calculation.

According to the plant operation simulation system described in (4) above, by changing the control logic of the control model of the emulator after the boost calculation, it is possible to check whether there is a large difference between the output data, which is output from the control model of the emulator, and the output data, which is output from the control function of the control device (whether there is any sudden change in the output data).

(5) In some embodiments, the plant operation simulation system described in any one of (1) to (4) further includes a plant model, inside or outside the emulator, that is a plant model (for example, the plant model Mp) simulating the plant and that generates input data to be input to the control model of the emulator according to output data of the control model of the emulator.

According to the plant operation simulation system described in (5) above, by checking the effect of change in the control logic of the control model of the emulator on the input data generated with the plant model, it is possible to understand the effect of change in the control logic of the control function of the control device on the output of the plant. Therefore, the control logic of the control function of the control device can be appropriately adjusted in consideration of the input data generated with the plant model.

(6) In some embodiments, in the plant operation simulation system described in any one of (1) to (5), the control device is configured to add a time stamp of reception time to reception data (for example, the operation command from the man-machine device 8 or the communication data from the external device 20), which the control device has received in addition to the input data, and transfer the reception data to the emulator, and the emulator is configured to store the reception data received from the control device in the storage device and reproduce the reception data at a time indicated by the time stamp added to the reception data while the boost calculation is being executed.

According to the plant operation simulation system described in (6) above, even when the control device receives communication data from other devices and receives an operation command from the man-machine device, and a state of the control logic of the control function of the control device is changed, in a process of duplicating the operating state of the plant at certain time point (including an internal state of the control device) with the emulator, the operating state of the plant can be duplicated by the emulator.

(7) In some embodiments, in the plant operation simulation system described in any one of (1) to (6), the control device is configured to repeat an operation, which includes adding a time stamp to a snapshot of a calculation result obtained by using the control function of the control device and transferring the snapshot to which the time stamp is added to the emulator, a plurality of times, and the emulator is s configured to store each of the snapshots transferred from the control device in the storage device (for example, the HDD 78).

According to the plant operation simulation system described in (7) above, the calculation result of the control function of the control device can be sequentially stored in the emulator. As a result, when a trip or the like occurs in the plant, it becomes possible to check a past calculation state in the control device by using the snapshot stored in the storage device, and the cause of the trip can be investigated.

(8) A plant operation simulation method according to at least one embodiment of the present disclosure is a plant operation simulation method of using a control device (for example, the control device 4) that has a control function (for example, the control function Mc) of outputting output data for controlling a plant by receiving input data related to a state quantity of the plant and an emulator (for example, the emulator 6) that includes a control model (for example, the control model Md) simulating the control function of the control device and that is time-synchronized with the control device, the plant operation simulation method including: a step of causing the control device and the emulator to receive the input data at a cycle common to the control device and the emulator; a step of adding a time stamp to the input data received by the emulator and storing the input data; a step of adding a time stamp to a snapshot (for example, the snapshot Qn) of a calculation result obtained by using the control function of the control device at any time (for example, the time tn) and transferring the snapshot to the emulator; and a step of executing a boost calculation for performing a calculation of the control model of the emulator at a cycle faster than a cycle of a calculation performed by using the control function of the control device until reaching a calculation time of the control function in the control device at a current time point, by using the calculation result included in the snapshot and the input data to which a time stamp at or after the time, which is indicated by the time stamp added to the snapshot, is added.

According to the plant operation simulation system described in (8) above, the emulator, which is time-synchronized with the control device and includes the control model simulating the control function, executes the boost calculation for performing the calculation of the control model of the emulator at the cycle faster than the calculation cycle of the control function of the control device until reaching a calculation time of the control function in the control device at a current time point, by using the calculation result (the intermediate value of the calculation performed by using the control function), at a certain time point, included in the snapshot transferred from the control device and the input data to which a time stamp at or after the time, which is indicated by the time stamp added to the snapshot, is added. Therefore, the operating state of the plant at a certain time point can be reproduced by the emulator which is different from the control device. Therefore, an effect (for example, whether the output value of the control device is changed suddenly or the like) of change in the control logic, when the change is made in the control logic of the control device from this state, on the output value of the control device can be checked by using the emulator before the control logic of the control device is changed while the plant is in operation. Therefore, it is possible to reduce a risk of an emergency stop of a control target of the plant or an unexpected accident.

### REFERENCE SIGNS LIST

2 plant operation simulation system
4 control device
6 emulator
8 man-machine device
10 information communication network
12 control communication network
14 input/output module
16 control logic change unit
18 output data comparison unit
20 external device
72 processor
74 RAM
76 ROM
78 HDD
80 input I/F
82 output I/F
84 bus
100 plant
Mc control function
Md control model
Mp plant model
Qn snapshot

1. A plant operation simulation system comprising:
a control device that has a control function of outputting output data for controlling a plant by receiving input data related to a state quantity of the plant; and
an emulator that includes a control model simulating the control function of the control device and that is time-synchronized with the control device, wherein
the control device and the emulator are configured to receive the input data at a cycle common to the control device and the emulator,
the emulator is configured to add a time stamp to the input data received by the emulator and store the input data in a storage device,
the control device is configured to add a time stamp to a snapshot of a calculation result obtained by using the control function of the control device at any time and transfer the snapshot to the emulator, and
the emulator is configured to execute a boost calculation for performing a calculation of the control model of the emulator at a cycle faster than a cycle of a calculation performed by using the control function of the control device until reaching a calculation time of the control function in the control device at a current time point, by using the calculation result included in the snapshot transferred from the control device and the input data to which a time stamp at or after the time, which is indicated by the time stamp added to the snapshot, is added.

2. The plant operation simulation system according to claim 1, wherein
the emulator is configured to use the calculation result, which is included in the snapshot transferred from the control device, as an initial value of the boost calculation.

3. The plant operation simulation system according to claim 1, wherein
the control device is configured to divide the snapshot into a plurality of data and transfer the plurality of data to the emulator over a plurality of calculation cycles.

4. The plant operation simulation system according to claim 1, further comprising:
an output data comparison unit that is configured to compare output data, which is output from the control model of the emulator, and output data, which is output from the control function of the control device, when a control logic of the control model of the emulator is changed after the boost calculation.

5. The plant operation simulation system according to claim 1, further comprising:
a plant model, inside or outside the emulator, that is a plant model simulating the plant and that generates input data to be input to the control model of the emulator according to output data of the control model of the emulator.

6. The plant operation simulation system according to claim 1, wherein
the control device is configured to add a time stamp of reception time to reception data, which the control device has received in addition to the input data, and transfer the reception data to the emulator, and
the emulator is configured to store the reception data received from the control device in the storage device and reproduce the reception data at a time indicated by the time stamp added to the reception data while the boost calculation is being executed.

7. The plant operation simulation system according to claim 1, wherein
the control device is configured to repeat an operation, which includes adding a time stamp to a snapshot of a calculation result obtained by using the control function of the control device and transferring the snapshot to which the time stamp is added to the emulator, a plurality of times, and
the emulator is configured to store each of the snapshots transferred from the control device in the storage device.

8. A plant operation simulation method of using a control device that has a control function of outputting output data for controlling a plant by receiving input data related to a state quantity of the plant and an emulator that includes a control model simulating the control function of the control device and that is time-synchronized with the control device, the plant operation simulation method comprising:
a step of causing the control device and the emulator to receive the input data at a cycle common to the control device and the emulator;
a step of adding a time stamp to the input data received by the emulator and storing the input data;
a step of adding a time stamp to a snapshot of a calculation result obtained by using the control function of the control device at any time and transferring the snapshot to the emulator; and
a step of executing a boost calculation for performing a calculation of the control model of the emulator at a cycle faster than a cycle of a calculation performed by using the control function of the control device until reaching a calculation time of the control function in the control device at a current time point, by using the calculation result included in the snapshot and the input data to which a time stamp at or after the time, which is indicated by the time stamp added to the snapshot, is added.
